(19) United States
(12) Patent Application Publication
(10) Pub. No.: US 2020/0213066 A1
(43) Pub. Date: Jul. 2, 2020

(54) BANDWIDTH PART CONFIGURATION METHOD, NETWORK DEVICE AND USER EQUIPMENT

(71) Applicant: VIVO MOBILE COMMUNICATION CO.,LTD., Chang'an Dongguan, Guangdong (CN)

(72) Inventors: Yue MA, Chang'an Dongguan (CN); Yumin WU, Chang'an Dongguan (CN); Li CHEN, Chang'an Dongguan (CN); Xiaodong YANG, Chang'an Dongguan (CN)

(73) Assignee: VIVO MOBILE COMMUNICATION CO.,LTD., Chang'an Dongguan, Guangdong (CN)

(21) Appl. No.: 16/637,746

(22) PCT Filed: Aug. 7, 2018
(86) PCT No.: PCT/CN2018/099120

§ 371 Date: Feb. 8, 2020

(30) Foreign Application Priority Data
Aug. 11, 2017 (CN) 201710687867.2

(51) Int. Cl. H04L 5/00; H04W 8/24; H04W 72/04; H04W 76/15

(52) U.S. Cl. CPC H04L 5/0092; H04W 8/24; H04W 92/10; H04W 76/15; H04W 72/0453

(57) ABSTRACT

A BWP configuration method, a network device and a UE are provided. The BWP configuration method includes: receiving UE capability information carrying BWP capability information reported by a UE; and configuring an air interface parameter set of at least one BWP for the UE in accordance with the UE capability information. The air interface parameter set includes at least one air interface parameter of the BWP.

### CROSS-REFERENCE TO RELATED APPLICATION

The present application claims a priority of the Chinese patent application No. 201710687867.2 filed on Aug. 11, 2017, which is incorporated herein by reference in its entirety.

### TECHNICAL FIELD

The present disclosure relates to the field of communication technology, in particular to a Bandwidth Part (BWP) configuration method, a network device and a User Equipment (UE).

### BACKGROUND

As compared with a conventional mobile communication system, a 5^{th}-Generation (5G) mobile communication system, also called as a New Radio (NR) system, needs to adapt to various scenarios and service requirements. In order to meet the requirements on different services and scenarios, in the 5G system, a cell covered by a network device may support a relatively large bandwidth (e.g., 100 MHz), but a UE may merely support a relatively small operating bandwidth (e.g., 5 MHz). The operating bandwidth for the UE may be considered as a BWP of the larger bandwidth.

In terms of a physical layer, the BWP refers to the division of a carrier with a large bandwidth into several parts, and each part has a relatively small bandwidth. For the UE in a connected state, one or more BWPs may be allocated or activated for the UE for the transmission of data and control. Because this is an operation made on the carrier with a large bandwidth, it is different from that in conventional carrier aggregation. However, there is currently no air-interface configuration scheme in this scenario in the related art.

### SUMMARY

In one aspect, the present disclosure provides in some embodiments a BWP configuration method applied for a network device, including: receiving UE capability information carrying BWP capability information reported by a UE; and configuring an air interface parameter set of at least one BWP for the UE in accordance with the UE capability information, the air interface parameter set including at least one air interface parameter of the BWP.

In another aspect, the present disclosure provides in some embodiments a network device, including: a first reception module configured to receive UE capability information carrying BWP capability information reported by a UE; and a configuration module configured to configure an air interface parameter set of at least one BWP for the UE in accordance with the UE capability information, the air interface parameter set including at least one air interface parameter of the BWP.

In yet another aspect, the present disclosure provides in some embodiments a network device, including a processor, a memory, and a program stored in e memory and executed by the processor. The processor is configured to implement the above-mentioned BWP configuration method.

In still yet another aspect, the present disclosure provides in some embodiments a computer-readable storage medium storing therein a program. The program is executed by a processor so as to implement the above-mentioned BWP configuration method.

In still yet another aspect, the present disclosure provides in some embodiments a BWP configuration method for a UE, including: reporting UE capability information carrying BWP capability information to a network device; and receiving an air interface parameter set of at least one BWP configured by the network device in accordance with the UE capability information, the air interface parameter set including at least one air interface parameter of the BWP.

In still yet another aspect, the present disclosure provides in some embodiments a UE, including: a reporting module configured to report UE capability information carrying BWP capability information to a network device; and a fourth reception module configured to receive an air interface parameter set of at least one BWP configured by the network device in accordance with the UE capability information, the air interface parameter set including at least one air interface parameter of the BWP.

In still yet another aspect, the present disclosure provides in some embodiments a UE, including a processor, a memory, and a program stored in the memory and executed by the processor. The processor is configured to execute the program so as to implement the above-mentioned BWP configuration method.

In still yet another aspect, the present disclosure provides in some embodiments a computer-readable storage medium storing therein a program. The program is executed by a processor so as to implement the above-mentioned BWP configuration method.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a flow chart of a BWP configuration method for a network device according to one embodiment of the present disclosure;

FIG. 2 is a schematic view showing basic procedures of the BWP configuration method according to one embodiment of the present disclosure;

FIG. 3 is a schematic view showing procedures of requesting other system information according to one embodiment of the present disclosure;

FIG. 4 is a schematic view showing the network device according to one embodiment of the present disclosure;

FIG. 5 is a block diagram of the network device according to one embodiment of the present disclosure;

FIG. 6 is a flow chart of a BWP configuration method for a UE according to one embodiment of the present disclosure;

FIG. 7 is a schematic view showing the UE according to one embodiment of the present disclosure; and

FIG. 8 is a block diagram of the UE according to one embodiment of the present disclosure.

### DETAILED DESCRIPTION

The present disclosure will be described hereinafter in conjunction with the drawings and embodiments. The following embodiments are for illustrative purposes only, but shall not be used to limit the scope of the present disclosure. Actually, the embodiments are provided so as to facilitate the understanding of the scope of the present disclosure.

Such words as “first” and “second” involved in the description and the appended claims are merely used to differentiate different objects rather than to represent any specific order. It should be appreciated that, the data used in this way may be replaced with each other, so as to implement the embodiments in an order other than that shown in the drawings or described in the description. In addition, such terms as “include” or “including” or any other variations involved in the present disclosure intend to provide non-exclusive coverage, so that a procedure, method, system, product or device including a series of steps or units may also include any other elements not listed herein, or may include any inherent steps or units of the procedure, method, system, product or device.

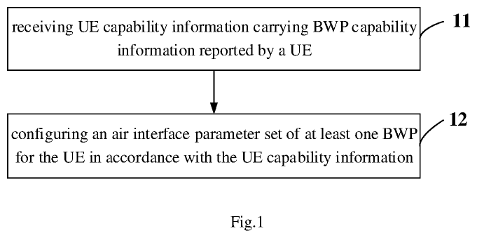

The present disclosure provides in some embodiments a BWP configuration method applied for a network device which, as shown in FIG. 1, includes Steps 11 and 12.

Step 11: receiving UE capability information carrying BWP capability information reported by a UE.

The UE capability information may be used to indicate a UE air interface capability, especially the UE air interface capability based on BWPs.

Step 12: configuring an air interface parameter set of at least one BWP for the UE in accordance with the UE capability information. The air interface parameter set may include at least one air interface parameter of the BWP.

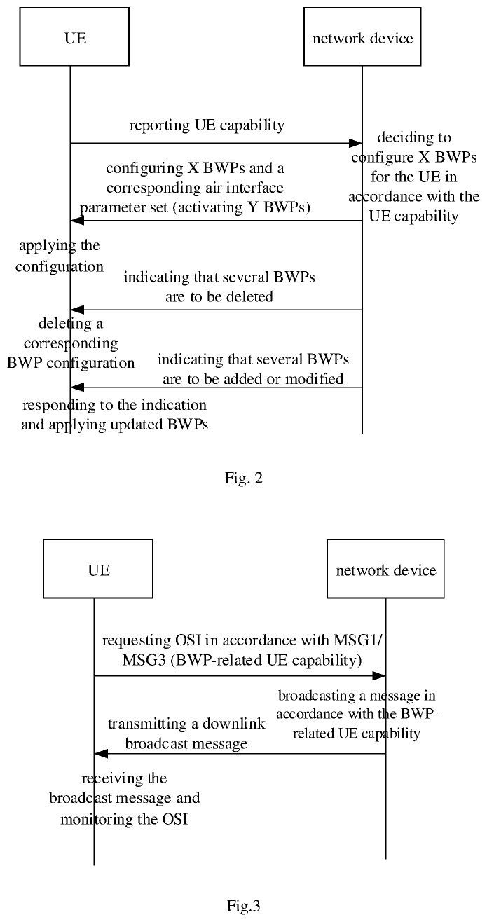

To be specific, as shown in FIG. 2, the UE may notify the network device of its own BWP-related capability through reporting UE capability, e.g., the capability of at most supporting X BWPs. At this time, the network device may decide to configure X BWPs for the UE in accordance with the UE capability, and further configure the X BWPs and a corresponding air interface parameter set for the UE. The network device may simultaneously indicate that Y of the X BWPs are to be activated, where Y is smaller than or equal to X. Upon the receipt of the corresponding air interface parameter set, the UE may use the above-mentioned configuration.

Subsequent to Step 12, the BWP configuration method may further include: when it is necessary to add or modify the BWPs for the UE, transmitting information about the to-be-added or to-be-modified BWPs to the UE; and when it is necessary to delete the BWPs for the UE, transmitting information about a list of the to-be-deleted BWPs to the UE. In other words, after the network device has configured the corresponding BWPs for the UE, the network device may further add the BWPs or modify or delete some BWPS in accordance with a real-time network communication state, a UE service requirement or a resource scheduling situation. As shown in FIG. 2, when the network device indicates the deletion of several BWPs, the UE may delete corresponding BWP configurations. When the network device indicates the addition or modification of several BWPs, the UE may respond to this indication and use the updated BWPs.

The information about the BWPs may include at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP when there is a correspondence between the uplink and downlink BWPs, configuration information about a Random Access Channel (RACH) for the UE with respect to each to-be-added or to-be-modified BWP, information about a power control parameter of the UE with respect to each to-be-added or to-be-modified BWP, cross-BWP scheduling configuration information, and configuration information about a physical channel for the UE with respect to each to-be-added or to-be-modified BWP.

To be specific, the configuration information about the physical channel may include at least one of configuration-related information about a Physical Downlink Control Channel (PDCCH), configuration-related information about a Physical Downlink Shared Channel (PDSCH), configuration-related information about a Physical Uplink Shared Channel (PUSCH), configuration-related information about a Physical Uplink Control Channel (PUCCH), configuration-related information about a Sounding Reference Signal (SRS), configuration-related information about a Physical Random Access Channel (PRACH), configuration-related information about a Physical Broadcast Channel (PBCH), configuration-related information about a Scheduling Request (SR), configuration-related information about a reference signal such as Channel State Information Reference Signal (CSI-RS)/Tracking Reference Signal (TRS)/Phase Tracking Reference Signal (PTRS)/Demodulation Reference Signal (DMRS), and configuration-related information about a channel state report.

The UE capability information may include at least one of: capability information about the maximum quantity of BWPs capable of being configured for the UE simultaneously for uplink or downlink transmission and a bandwidth; capability information about the maximum quantity of BWPs capable of being activated by the UE simultaneously for the uplink or downlink transmission and a bandwidth; capability information about the quantity of consecutive or inconsecutive BWPs in a same carrier capable of being configured for the UE simultaneously and a bandwidth; capability information about the quantity of consecutive or inconsecutive BWPs in a same carrier capable of being activated by the UE simultaneously and a bandwidth; capability information about the quantity of BWPs capable of being configured for the UE simultaneously in different carriers and a bandwidth in the case of Carrier Aggregation (CA); capability information about the quantity of BWPs capable of being configured for the UE simultaneously in different carriers and a bandwidth in the case of Dual Connectivity (DC); capability information about the quantity of BWPs capable of being activated by the UE simultaneously in different carriers and a bandwidth in the case of CA; capability information about the quantity of BWPs capable of being activated by the UE simultaneously in different carriers and a bandwidth in the case of DC; Multiple-Input Multiple-Output (MIMO) capability information about each BWP to be supported by the UE; numerology information about each BWP to be supported by the UE, including a subcarrier spacing and a Cyclic Prefix (CP); first indication information indicating whether the UE has a cross-BWP scheduling capability; second indication information indicating whether the UE has a fast switching capability, i.e., indicating whether the UE has a transceiving capability of rapidly retuning from one BWP to another BWP provided that a certain performance requirement has been met; information about a retuning time length when the UE has the fast switching capability; BWP measurement gap capability information about the UE, i.e., information indicating whether a measurement gap needs to be provided for the measurement of another BWP when the UE operates at a certain BWP; third indication information indicating whether the UE has a capability of measuring, at a current BWP, different measurement items of the current BWP, i.e., indicating whether the UE has a capability of measuring, at a certain BWP, different measurement items of the BWP; fourth indication information indicating whether the UE has a capability of measuring, at one BWP, different measurement items of the other BWP; fifth indication information indicating whether a measurement gap needs to be configured for the UE when the UE has the capability of measuring, at one BWP, different measurement items of the other BWP, i.e., indicating whether the measurement gap needs to be configured for the UE during the measurement of a certain measurement item; sixth indication information indicating whether a measurement gap needs to be configured for the UE when the UE needs to transmit an SRS; and seventh indication information indicating whether a measurement gap needs to be configured for the UE when the UE performs intra-frequency multiple-beam (cross-transceiving multiple-beam) measurement on one BWP.

It should be appreciated that, the UE capability information may be reported to the network device through joint bandwidth.

The measurement items in the third indication information, the fourth indication information and the fifth indication information may include at least one of Reference Signal Received Power (RSRP), Reference Signal Received Quality (RSRQ), a Signal to Interference plus Noise Ratio (SINR), Received Signal Strength Indication (RSSI) and Channel Quality Indication (CQI).

Further, when a certain UE supports the carrier aggregation of Band X and Band Y, and there is one carrier CCₓ₁ at Band X and two inconsecutive carriers CC_{y1} and CC_{y2} at Band Y, the UE capability in an LTE system may be X−A+Y−C, where A represents one carrier, and C represents that the UE has a capability of performing carrier aggregation on two inconsecutive carriers at a certain band. In a BWP scenario, one carrier may be provided with a plurality of BWPs, and at this time, it is necessary to define different BWP combination types. To be specific, there may also exist a plurality of BWP combinations in a supported large-bandwidth carrier. The air interface parameter set may include an air interface parameter type of each BWP. The air interface parameter type may include at least one of: a first air interface parameter indicating that merely one BWP is capable of being configured or activated in a current carrier, i.e., merely one BWP is capable of being configured or activated in each carrier; a second air interface parameter indicating that at least two BWPs at consecutive positions are capable of being configured or activated in the current carrier, i.e., two or more BWPs at consecutive positions are capable of being configured or activated in each carrier; a third air interface parameter indicating that at least two BWPs at inconsecutive positions are capable of being configured or activated in the current carrier, i.e., two or more BWPs at inconsecutive positions are capable of being configured or activated in each carrier; a fourth air interface parameter indicating that at least three BWPs at consecutive positions and inconsecutive positions are capable of being configured or activated in the current carrier, i.e., a plurality of BWPs at consecutive positions and inconsecutive positions are capable of being configured or activated in each carrier; and a fifth air interface parameter indicating that at least one BWP at a predetermined position is capable of being configured or activated in the other carrier, i.e., one or more BWPs are capable of being configured or activated at a designated position in the other carrier. The other carrier may be a carrier other than the current carrier.

To be specific, Step 12 may include: configuring, by the network device, at least one BWP and the air interface parameter set of the at least one BWP for the UE in accordance with the UE capability information; and transmitting the air interface parameter set of the at least one BWP to the UE through a broadcast message or preset signaling. In other words, the network device may transmit the air interface parameter set of the at least one BWP to the UE through the broadcast message or the preset signaling.

The transmitting the air interface parameter set of the at least one BWP to the UE through the broadcast message or the preset signaling may include transmitting information about the correspondence between the uplink and downlink BWPs in the air interface parameter set of the at least one BWP to the UE through the broadcast message or the preset signaling. Here, the correspondence between the uplink and downlink BWPs may be determined through the broadcast message or dedicated signaling. The uplink and downlink BWPs may be a BWP pair consisting of an uplink BWP and a downlink BWP. The information about the correspondence between the uplink and downlink BWPs may include at least one of information about a feedback relationship between the uplink and downlink BWPs, scheduling information about the uplink and downlink BWPs, information about Timing Advance (TA) of the uplink and downlink BWPs, and path loss information about the uplink and downlink BWPs. The information about the feedback relationship between the uplink and downlink BWPs may include the feedback relationship such as Hybrid Automatic Repeat reQuest (HARQ) feedback and a channel state.

Further, the transmitting the information about the correspondence between the uplink and downlink BWPs in the air interface parameter set of the at least one BWP to the UE may be implemented in the following modes.

Mode 1: the information about the correspondence between the uplink and downlink BWPs in the air interface parameter set of the at least one BWP may be transmitted to the UE through carrying a configuration of one of the uplink and downlink BWPs in a configuration of the other one of the uplink and downlink BWPs. In other words, the configuration of a certain downlink (or uplink) BWP may explicitly include the configuration of the associated uplink (or downlink) BWP.

Mode 2: the information about the correspondence between the uplink and downlink BWPs in the air interface parameter set of the at least one BWP may be transmitted to the UE through providing the uplink and downlink BWPs with a same configuration. In other words, a certain BWP pair may use the same configuration in accordance with a preset rule.

Mode 3: the information about the correspondence between the uplink and downlink BWPs in the air interface parameter set of the at least one BWP may be transmitted to the UE through configuring a predetermined variable. In other words, a configuration of the variable delta may be used.

Subsequent to transmitting the information about the correspondence between the uplink and downlink BWPs in the air interface parameter set of the at least one BWP to the UE through the broadcast message or the preset signaling, the BWP configuration method may further include: when the information about the correspondence between the uplink and downlink BWPs indicates that one downlink BWP corresponds to a plurality of uplink feedback BWPs, modifying an uplink feedback BWP adopted by the UE for the uplink transmission through the preset signaling. In other words, when an uplink control channel for a plurality of BWPs has been configured, the used BWP feedback may be modified through signaling.

In addition, subsequent to Step 12, the BWP configuration method may further include: receiving request information for requesting On-demand System Information (or other System Information, OSI) from the UE; and transmitting the OSI requested by the request information to the UE in accordance with the UE capability information through the at least one BWP configured for the UE.

The request information may carry the UE capability information about the UE. To be specific, a procedure of requesting the OSI may include receiving the request information for requesting the OSI from the UE through a message 1 (MSG1) or a message 3 (MSG3). In other words, as shown in FIG. 3, during the requesting of the OSI, when a default BWP has been indicated for the requesting of the SI and the transmission of a corresponding broadcast message, it is unnecessary for the network device to acquire the UE capability. When no default BWP has been indicated for the requesting of the SI and the transmission of a corresponding broadcast message and the network device does not acquire the UE capability, it is necessary to carry the BWP-related UE capability or the BWP for receiving the broadcast message in the request information for requesting the OSI included in the MSG1 or MSG3, so that the network device may determine the BWP for the transmission of the downlink broadcast message in accordance with the BWP-related UE capability. The UE may receive the corresponding broadcast message, and monitor the OSI.

In addition, subsequent Step 12, the BWP configuration method may further include: transmitting L1/L2/L3 measurement configuration information at a designated BWP of the at least one BWP to the UE in accordance with the air interface parameter set of the at least one BWP; receiving measurement report information reported by the UE after the measurement in accordance with the measurement configuration information; and updating the air interface parameter set for the UE in accordance with the measurement report information. L1 represents a physical layer, L2 represents a high layer, and L3 represents a Radio Resource Control (RRC) layer.

The updating the air interface parameter set for the UE in accordance with the measurement report information may include: when the measurement report information indicates that it is necessary to perform BWP switching, configuring indication information indicating whether or not to configure a measurement gap in the air interface parameter set. In other words, when a certain BWP has been configured and activated by the UE, for measurement, the network device wants the UE to provide the measurement item of the other BWP in a same carrier, so that the network device may determine how to switch to the other BWP. The BWP switching is a procedure performed at the physical layer, so an additional L1 measurement item needs to be provided, and a new measurement gap corresponding to the L1 measurement item needs to be configured. The measurement gap may be used to measure such L1 measurement items as SINR/CQI.

According to the BWP configuration method in the embodiments of the present disclosure, upon the receipt of the UE capability information reported by the UE, the network device may flexibly configure at least one BWP for the UE and the air interface parameter set of the at least one BWP in accordance with the UE capability information. As a result, it is able to configure the air interface parameters in accordance with the BWPs which cannot be solved in the related art.

The BWP configuration method in different scenarios has been described hereinabove, and the corresponding network device will be described hereinafter in conjunction with the drawings.

As shown in FIG. 4, the present disclosure further provides in some embodiments a network device 400 capable of implementing the above-mentioned BWP configuration method, i.e., receiving UE capability information carrying BWP capability information reported by a UE, and configuring an air interface parameter set of at least one BWP for the UE in accordance with the UE capability information, with a same technical effect. The network device 400 includes: a first reception module 410 configured to receive the UE capability information carrying the BWP capability information reported by the UE; and a configuration module 420 configured to configure the air interface parameter set of the at least one BWP for the UE in accordance with the UE capability information. The air interface parameter set may include at least one air interface parameter of the BWP.

The UE capability information may include at least one of: capability information about the maximum quantity of BWPs capable of being configured for the UE simultaneously for uplink or downlink transmission and a bandwidth; capability information about the maximum quantity of BWPs capable of being activated by the UE simultaneously for the uplink or downlink transmission and a bandwidth; capability information about the quantity of consecutive or inconsecutive BWPs in a same carrier capable of being configured for the UE simultaneously and a bandwidth; capability information about the quantity of consecutive or inconsecutive BWPs in a same carrier capable of being activated by the UE simultaneously and a bandwidth; capability information about the quantity of BWPs capable of being configured for the UE simultaneously in different carriers and a bandwidth in the case of Carrier Aggregation (CA); capability information about the quantity of BWPs capable of being configured for the UE simultaneously in different carriers and a bandwidth in the case of Dual Connectivity (DC); capability information about the quantity of BWPs capable of being activated by the UE simultaneously in different carriers and a bandwidth in the case of CA; capability information about the quantity of BWPs capable of being activated by the UE simultaneously in different carriers and a bandwidth in the case of DC; Multiple-Input Multiple-Output (MIMO) capability information about each BWP to be supported by the UE; numerology information about each BWP to be supported by the UE, including a subcarrier spacing and a Cyclic Prefix (CP); first indication information indicating whether the UE has a cross-BWP scheduling capability; second indication information indicating whether the UE has a fast switching capability, i.e., indicating whether the UE has a transceiving capability of rapidly retuning from one BWP to another BWP provided that a certain performance requirement has been met; information about a retuning time length when the UE has the fast switching capability; BWP measurement gap capability information about the UE, i.e., information indicating whether a measurement gap needs to be provided for the measurement of another BWP when the UE operates at a certain BWP; third indication information indicating whether the UE has a capability of measuring, at a current BWP, different measurement items of the current BWP, i.e., indicating whether the UE has a capability of measuring, at a certain BWP, different measurement items of the BWP; fourth indication information indicating whether the UE has a capability of measuring, at one BWP, different measurement items of the other BWP; fifth indication information indicating whether a measurement gap needs to be configured for the UE when the UE has the capability of measuring, at one BWP, different measurement items of the other BWP, i.e., indicating whether the measurement gap needs to be configured for the UE during the measurement of a certain measurement item; sixth indication information indicating whether a measurement gap needs to be configured for the UE when the UE needs to transmit an SRS; and seventh indication information indicating whether a measurement gap needs to be configured for the UE when the UE performs intra-frequency multiple-beam measurement on one BWP.

The measurement items may include at least one of RSRP, RSRQ, an SINR, RSSI and CQI.

The air interface parameter set may include an air interface parameter type. The air interface parameter type may include at least one of: a first air interface parameter indicating that merely one BWP is capable of being configured or activated in a current carrier; a second air interface parameter indicating that at least two BWPs at consecutive positions are capable of being configured or activated in the current carrier; a third air interface parameter indicating that at least two BWPs at inconsecutive positions are capable of being configured or activated in the current carrier; a fourth air interface parameter indicating that at least three BWPs at consecutive positions and inconsecutive positions are capable of being configured or activated in the current carrier; and a fifth air interface parameter indicating that at least one BWP at a predetermined position is capable of being configured or activated in the other carrier, the other carrier being a carrier other than the current carrier.

The configuration module 420 may include: a configuration sub-module configured to configure at least one BWP and the air interface parameter set of the at least one BWP for the UE in accordance with the UE capability information; and a first transmission sub-module configured to transmit the air interface parameter set of the at least one BWP to the UE through a broadcast message or preset signaling.

The first transmission sub-module may include a first transmission unit configured to transmit information about the correspondence between the uplink and downlink BWPs in the air interface parameter set of the at least one BWP to the UE through the broadcast message or the preset signaling. The uplink and downlink BWPs may be a BWP pair consisting of an uplink BWP and a downlink BWP. The information about the correspondence between the uplink and downlink BWPs may include at least one of information about a feedback relationship between the uplink and downlink BWPs, scheduling information about the uplink and downlink BWPs, information about TA of the uplink and downlink BWPs, and path loss information about the uplink and downlink BWPs.

The first transmission unit may include: a first transmission sub-unit configured to transmit the information about the correspondence between the uplink and downlink BWPs in the air interface parameter set of the at least one BWP to the UE through carrying a configuration of one of the uplink and downlink BWPs in a configuration of the other one of the uplink and downlink BWPs; or a second transmission sub-unit configured to transmit the information about the correspondence between the uplink and downlink BWPs in the air interface parameter set of the at least one BWP to the UE through providing the uplink and downlink BWPs with a same configuration; or a third transmission sub-unit configured to transmit the information about the correspondence between the uplink and downlink BWPs in the air interface parameter set of the at least one BWP to the UE through configuring a predetermined variable.

The first transmission sub-module may further include an indication unit configured to, when the information about the correspondence between the uplink and downlink BWPs indicates that one downlink BWP corresponds to a plurality of uplink feedback BWPs, modify an uplink feedback BWP adopted by the UE for the uplink transmission through the preset signaling.

The network device 400 may further include: a second reception module configured to receive request information for requesting OSI from the UE, the request information carrying the UE capability information about the UE; and a first transmission module configured to transmit the OSI requested by the request information to the UE in accordance with the UE capability information through the at least one BWP configured for the UE.

The second reception module may include a first reception sub-module configured to receive the request information for requesting the OSI from the UE through MSG1 or MSG3.

The network device 400 may further include: a second transmission module configured to transmit L1/L2/L3 measurement configuration information at a designated BWP of the at least one BWP to the UE in accordance with the air interface parameter set of the at least one BWP; a third reception module configured to receive measurement report information reported by the UE after the measurement in accordance with the measurement configuration information; and an updating module configured to update the air interface parameter set for the UE in accordance with the measurement report information.

The updating module may include a first updating sub-module configured to, when the measurement report information indicates that it is necessary to perform BWP switching, configure indication information indicating whether or not to configure a measurement gap in the air interface parameter set.

The network device 400 may further include a third transmission module configured to, when it is necessary to add or modify the BWPs for the UE, transmit information about the to-be-added or to-be-modified BWPs to the UE. The information about the BWPs may include at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP, configuration information about an RACH for the UE with respect to each to-be-added or to-be-modified BWP, information about a power control parameter of the UE with respect to each to-be-added or to-be-modified BWP, cross-BWP scheduling configuration information, and configuration information about a physical channel for the UE with respect to each to-be-added or to-be-modified BWP.

The network device 400 may further include a fourth transmission module configured to, when it is necessary to delete the BWPs for the UE, transmit information about a list of the to-be-deleted BWPs to the UE.

It should be appreciated that, according to the embodiments of the present disclosure, upon the receipt of the UE capability information reported by the UE, the network device may flexibly configure at least one BWP for the UE and the air interface parameter set of the at least one BWP in accordance with the UE capability information. As a result, it is able to configure the air interface parameters in accordance with the BWPs which cannot be solved in the related art.

In order to achieve the above-mentioned purposes in a better manner, the present disclosure further provides in some embodiments a network device, including a processor, a memory, and a computer program stored in the memory and executed by the processor. The processor is configured to execute the computer program, so as to implement the above-mentioned BWP configuration method. The present disclosure further provides in some embodiments a computer-readable storage medium storing therein a computer program. The computer program is executed by a processor so as to implement the above-mentioned BWP configuration method.

The present disclosure further provides in some embodiments a network device 500 which, as shown in FIG. 5, includes an antenna 51, a Radio Frequency (RF) unit 52, and a baseband unit 53. The antenna 51 is connected to the RF unit 52. In an uplink direction, the RF unit 52 is configured to receive information via the antenna 51, and transmit the received information to the baseband unit 53 for processing. In a downlink direction, the baseband unit 53 is configured to process to-be-transmitted information, and transmit the processed information to the RF unit 52. The RF unit 52 is configured to process the received information and transmit the processed information via the antenna 51.

A frequency band processing unit may be located within the baseband unit 53, so that the above method for the network device may be implemented within the baseband unit 53. The baseband unit 53 may include a processor 54 and a memory 55.

The baseband unit 53 may, e.g., include at least one baseband board on which a plurality of chips is located, as shown in FIG. 5. One chip may be, e.g., the processor 54 connected to the memory 55 and configured to call a program stored in the memory 55 so as to perform operations for the network device in the above-mentioned method embodiments.

The baseband unit 53 may further include a network interface 56 configured to exchange information with the RF unit 52. The network interface may be, e.g., a Common Public Radio Interface (CPRI).

Here, the processor may include merely one processor, or a plurality of processing elements. For example, the processor may be a CPU, an ASIC, or one or more ICs configured to implement the above-mentioned method for the network device, e.g., one or more DSPs, or one or more FPGAs. The memory may include merely one memory, or a plurality of storage elements.

It should be appreciated that, the memory 55 may be a volatile memory, a nonvolatile memory or both. The nonvolatile memory may be a Read-Only Memory (ROM), a Programmable ROM (PROM), an Erasable PROM (EPROM), an electrically EPROM (EEPROM) or a flash memory. The volatile memory may be a Random Access Memory (RAM) which serves as an external high-speed cache. Illustratively but nonrestrictively, the RAM may include Static RAM (SRAM), Dynamic RAM (DRAM), Synchronous DRAM (SDRAM), Double Data Rate SDRAM (DDRSDRAM), Enhanced SDRAM (ESDRAM), Synchronous Link DRAM (SLDRAM) or Direct Rambus RAM (DRRAM). The memory 55 intends to include, but not limited to, the above-mentioned and any other appropriate memories.

To be specific, in some embodiments of the present disclosure, the network device may further include a computer program stored in the memory 55 and executed by the processor 54. The processor 54 is configured to call the computer program in the memory 55 so as to implement the method executed by the modules in FIG. 4.

To be specific, the processor 54 is further configured to call the computer program, so as to: receive the UE capability information carrying the BWP capability information reported by the UE; and configure the air interface parameter set of the at least one BWP for the UE in accordance with the UE capability information. The air interface parameter set may include at least one air interface parameter of the BWP.

To be specific, the UE capability information may include at least one of: capability information about the maximum quantity of BWPs capable of being configured for the UE simultaneously for uplink or downlink transmission and a bandwidth; capability information about the maximum quantity of BWPs capable of being activated by the UE simultaneously for the uplink or downlink transmission and a bandwidth; capability information about the quantity of consecutive or inconsecutive BWPs in a same carrier capable of being configured for the UE simultaneously and a bandwidth; capability information about the quantity of consecutive or inconsecutive BWPs in a same carrier capable of being activated by the UE simultaneously and a bandwidth; capability information about the quantity of BWPs capable of being configured for the UE simultaneously in different carriers and a bandwidth in the case of Carrier Aggregation (CA); capability information about the quantity of BWPs capable of being configured for the UE simultaneously in different carriers and a bandwidth in the case of Dual Connectivity (DC); capability information about the quantity of BWPs capable of being activated by the UE simultaneously in different carriers and a bandwidth in the case of CA; capability information about the quantity of BWPs capable of being activated by the UE simultaneously in different carriers and a bandwidth in the case of DC; Multiple-Input Multiple-Output (MIMO) capability information about each BWP to be supported by the UE; numerology information about each BWP to be supported by the UE, including a subcarrier spacing and a Cyclic Prefix (CP); first indication information indicating whether the UE has a cross-BWP scheduling capability; second indication information indicating whether the UE has a fast switching capability, i.e., indicating whether the UE has a transceiving capability of rapidly retuning from one BWP to another BWP provided that a certain performance requirement has been met; information about a retuning time length when the UE has the fast switching capability; BWP measurement gap capability information about the UE, i.e., information indicating whether a measurement gap needs to be provided for the measurement of another BWP when the UE operates at a certain BWP; third indication information indicating whether the UE has a capability of measuring, at a current BWP, different measurement items of the current BWP, i.e., indicating whether the UE has a capability of measuring, at a certain BWP, different measurement items of the BWP; fourth indication information indicating whether the UE has a capability of measuring, at one BWP, different measurement items of the other BWP; fifth indication information indicating whether a measurement gap needs to be configured for the UE when the UE has the capability of measuring, at one BWP, different measurement items of the other BWP, i.e., indicating whether the measurement gap needs to be configured for the UE during the measurement of a certain measurement item; sixth indication information indicating whether a measurement gap needs to be configured for the UE when the UE needs to transmit an SRS; and seventh indication information indicating whether a measurement gap needs to be configured for the UE when the UE performs intra-frequency multiple-beam measurement on one BWP.

To be specific, the measurement items may include at least one of RSRP, RSRQ, an SINR, RSSI and CQI.

To be specific, the air interface parameter set may include an air interface parameter type. The air interface parameter type may include at least one of: a first air interface parameter indicating that merely one BWP is capable of being configured or activated in a current carrier; a second air interface parameter indicating that at least two BWPs at consecutive positions are capable of being configured or activated in the current carrier; a third air interface parameter indicating that at least two BWPs at inconsecutive positions are capable of being configured or activated in the current carrier; a fourth air interface parameter indicating that at least three BWPs at consecutive positions and inconsecutive positions are capable of being configured or activated in the current carrier; and a fifth air interface parameter indicating that at least one BWP at a predetermined position is capable of being configured or activated in the other carrier, the other carrier being a carrier other than the current carrier.

To be specific, the processor 54 is further configured to call the computer program so as to: configure at least one BWP and the air interface parameter set of the at least one BWP for the UE in accordance with the UE capability information; and transmit the air interface parameter set of the at least one BWP to the UE through a broadcast message or preset signaling.

To be specific, the processor 54 is further configured to call the computer program, so as to transmit information about the correspondence between the uplink and downlink BWPs in the air interface parameter set of the at least one BWP to the UE through the broadcast message or the preset signaling. The uplink and downlink BWPs may be a BWP pair consisting of an uplink BWP and a downlink BWP. The information about the correspondence between the uplink and downlink BWPs may include at least one of information about a feedback relationship between the uplink and downlink BWPs, scheduling information about the uplink and downlink BWPs, information about TA of the uplink and downlink BWPs, and path loss information about the uplink and downlink BWPs.

To be specific, the processor 54 is further configured to call the computer program so as to: transmit the information about the correspondence between the uplink and downlink BWPs in the air interface parameter set of the at least one BWP to the UE through carrying a configuration of one of the uplink and downlink BWPs in a configuration of the other one of the uplink and downlink BWPs; or transmit the information about the correspondence between the uplink and downlink BWPs in the air interface parameter set of the at least one BWP to the UE through providing the uplink and downlink BWPs with a same configuration; or transmit the information about the correspondence between the uplink and downlink BWPs in the air interface parameter set of the at least one BWP to the UE through configuring a predetermined variable.

To be specific, the processor 54 is further configured to call the computer program, so as to, when the information about the correspondence between the uplink and downlink BWPs indicates that one downlink BWP corresponds to a plurality of uplink feedback BWPs, modify an uplink feedback BWP adopted by the UE for the uplink transmission through the preset signaling.

To be specific, the processor 54 is further configured to call the computer program, so as to: receive request information for requesting OSI from the UE, the request information carrying the UE capability information about the UE; and transmit the OSI requested by the request information to the UE in accordance with the UE capability information through the at least one BWP configured for the UE.

To be specific, the processor 54 is further configured to call the computer program, so as to receive the request information for requesting the OSI from the UE through MSG1 or MSG3.

To be specific, the processor 54 is further configured to call the computer program, so as to: transmit L1/L2/L3 measurement configuration information at a designated BWP of the at least one BWP to the UE in accordance with the air interface parameter set of the at least one BWP; receive measurement report information reported by the UE after the measurement in accordance with the measurement configuration information; and update the air interface parameter set for the UE in accordance with the measurement report information.

To be specific, the processor 54 is further configured to call the computer program, so as to, when the measurement report information indicates that it is necessary to perform BWP switching, configure indication information indicating whether or not to configure a measurement gap in the air interface parameter set.

To be specific, the processor 54 is further configured to call the computer program, so as to, when it is necessary to add or modify the BWPs for the UE, transmit information about the to-be-added or to-be-modified BWPs to the UE. The information about the BWPs may include at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP, configuration information about an RACH for the UE with respect to each to-be-added or to-be-modified BWP, information about a power control parameter of the UE with respect to each to-be-added or to-be-modified BWP, cross-BWP scheduling configuration information, and configuration information about a physical channel for the UE with respect to each to-be-added or to-be-modified BWP.

To be specific, the processor 54 is further configured to call the computer program, so as to, when it is necessary to delete the BWPs for the UE, transmit information about a list of the to-be-deleted BWPs to the UE.

The network device may be a Base Transceiver Station (BTS) in a Global System of Mobile Communication (GSM) system or a Code Division Multiple Access (CDMA) system, a Node B (NB) in a Wideband Code Division Multiple Access (WCDMA) system, an Evolved Node B (eNB, or eNodeB) in an LTE system, a relay or an access point, or a base station in a 5G network, which will not be particularly defined herein.

According to the embodiments of the present disclosure, upon the receipt of the UE capability information reported by the UE, the network device may flexibly configure at least one BWP for the UE and the air interface parameter set of the at least one BWP in accordance with the UE capability information. As a result, it is able to configure the air interface parameters in accordance with the BWPs which cannot be solved in related art.

The BWP configuration method for the network device has been described hereinabove, and a BWP configuration method applied for a UE will be described hereinafter in conjunction with the drawings.

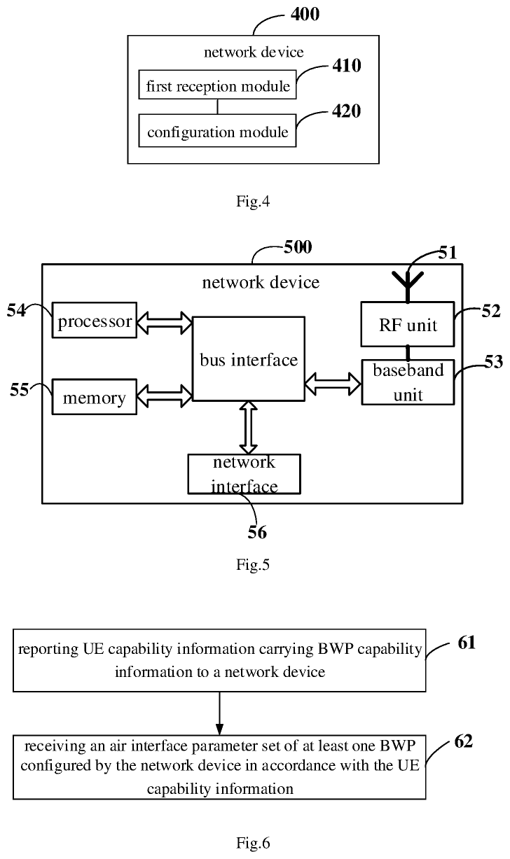

As shown in FIG. 6, the present disclosure further provides in some embodiments a BWP configuration method applied for a UE, which includes the following Steps 61 and 62.

Step 61: reporting UE capability information carrying BWP capability information to a network device.

The UE capability information may be used to indicate a UE air interface capability, especially the UE air interface capability based on BWPs.

Step 62: receiving an air interface parameter set of at least one BWP configured by the network device in accordance with the UE capability information. The air interface parameter set may include at least one air interface parameter of the BWP.

Subsequent to Step 62, the BWP configuration method may further include: receiving information about to-be-added or to-be-modified BWPs from the network device; and receiving information about a list of to-be-deleted BWPs from the network device. In other words, when it is necessary to add or modify the BWPs for the UE, the network device may transmit the information about the to-be-added or to-be-modified BWPs to the UE, and when it is necessary to delete the BWPs for the UE, the network device may transmit the information about the list of the to-be-deleted BWPs to the UE.

The information about the BWPs may include at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP, configuration information about a Random Access Channel (RACH) for the UE with respect to each to-be-added or to-be-modified BWP, information about a power control parameter of the UE with respect to each to-be-added or to-be-modified BWP, cross-BWP scheduling configuration information, and configuration information about a physical channel for the UE with respect to each to-be-added or to-be-modified BWP.

The measurement items in the third indication information, the fourth indication information and the fifth indication information may include at least one of RSRP, RSRQ, an SINR, RSSI and CQI.

The air interface parameter set may include an air interface parameter type. The air interface parameter type may include at least one of: a first air interface parameter indicating that merely one BWP is capable of being configured or activated in a current carrier; a second air interface parameter indicating that at least two BWPs at consecutive positions are capable of being configured or activated in the current carrier; a third air interface parameter indicating that at least two BWPs at inconsecutive positions are capable of being configured or activated in the current carrier; a fourth air interface parameter indicating that at least two BWPs at different positions are capable of being configured or activated in the current carrier; and a fifth air interface parameter indicating that at least one BWP at a predetermined position is capable of being configured or activated in the other carrier, the other carrier being a carrier other than the current carrier.

Step 62 may include receiving at least one BWP and the air interface parameter set of the at least one BWP configured by the network device in accordance with the UE capability information through a broadcast message or preset signaling.

Especially, Step 62 may include receiving information about a correspondence between uplink and downlink BWPs in the air interface parameter set of the at least one BWP configured by the network device in accordance with the UE capability information. The uplink and downlink BWPs may be a BWP pair consisting of an uplink BWP and a downlink BWP. The information about the correspondence between the uplink and downlink BWPs may include at least one of information about a feedback relationship between the uplink and downlink BWPs, scheduling information about the uplink and downlink BWPs, information about TA of the uplink and downlink BWPs, and path loss information about the uplink and downlink BWPs. The information about the feedback relationship between the uplink and downlink BWPs may include the feedback relationship such as HARQ feedback and a channel state.

Further, the receiving the information about the correspondence between the uplink and downlink BWPs in the air interface parameter set of the at least one BWP configured by the network device in accordance with the UE capability information may include, but not limited to: receiving the information about the correspondence between the uplink and downlink BWPs in the air interface parameter set of the at least one BWP configured by the network device in accordance with the UE capability information through carrying a configuration of one of the uplink and downlink BWPs in a configuration of the other one of the uplink and downlink BWPs; or receiving the information about the correspondence between the uplink and downlink BWPs in the air interface parameter set of the at least one BWP configured by the network device in accordance with the UE capability information through providing the uplink and downlink BWPs with a same configuration; or receiving the information about the correspondence between the uplink and downlink BWPs in the air interface parameter set of the at least one BWP configured by the network device in accordance with the UE capability information through configuring a predetermined variable.

In addition, subsequent to Step 62, the BWP configuration method may further include: transmitting request information for requesting OSI to the network device in accordance with the air interface parameter set; and receiving the OSI requested by the request information from the network device through the at least one BWP configured for the UE.

To be specific, the transmitting the request information for requesting the OSI may include transmitting the request information for requesting the OSI to the network device through MSG1 or MSG3. During the requesting of the OSI, when a default BWP has been indicated for the requesting of the SI and the transmission of a corresponding broadcast message, it is unnecessary for the network device to acquire the UE capability. When no default BWP has been indicated for the requesting of the SI and the transmission of a corresponding broadcast message and the network device does not acquire the UE capability, it is necessary to carry the BWP-related UE capability or the BWP for receiving the broadcast message in the request information for requesting the OSI included in at least one of the MSG1 or MSG3, so that the network device may determine the BWP for the transmission of the downlink broadcast message.

In addition, subsequent to Step 62, the BWP configuration method may further include: receiving L1/L2/L3 measurement configuration information at a designated BWP of the at least one BWP from the network device; and performing measurement in accordance with the measurement configuration information to acquire measurement report information and report the measurement report information to the network device, so that the network device updates the air interface parameter set for the UE in accordance with the measurement report information.

According to the BWP configuration method in the embodiments of the present disclosure, the UE may report its own UE capability information to the network device, so that the network device may flexibly configure the corresponding BWP and the air interface parameter set for the UE in accordance with the UE capability information. As a result, it is able to configure the air interface parameters in accordance with the BWPs which cannot be solved in related art.

The BWP configuration method in different scenarios has been described hereinabove, and the corresponding UE will be described hereinafter in conjunction with the drawings.

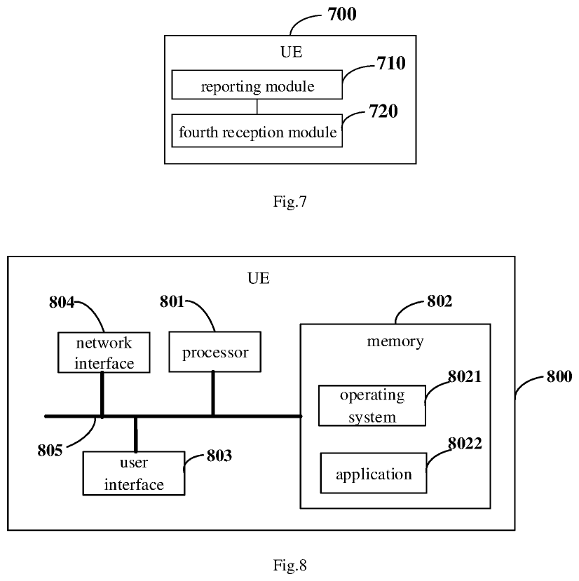

As shown in FIG. 7, the present disclosure further provides in some embodiments a UE 700 capable of implementing the above-mentioned BWP configuration method, i.e., reporting UE capability information carrying BWP capability information to a network device, and receiving an air interface parameter set of at least one BWP configured by the network device in accordance with the UE capability information, with a same technical effect. The UE 700 includes: a reporting module 710 configured to report the UE capability information carrying the BWP capability information to the network device; and a fourth reception module 720 configured to receive the air interface parameter set of at least one BWP configured by the network device in accordance with the UE capability information. The air interface parameter set may include at least one air interface parameter of the BWP.

The UE capability information may include at least one of: capability information about the maximum quantity of BWPs capable of being configured for the UE simultaneously for uplink or downlink transmission and a bandwidth; capability information about the maximum quantity of BWPs capable of being activated by the UE simultaneously for the uplink or downlink transmission and a bandwidth; capability information about the quantity of consecutive or inconsecutive BWPs in a same carrier capable of being configured for the UE simultaneously and a bandwidth; capability information about the quantity of consecutive or inconsecutive BWPs in a same carrier capable of being activated by the UE simultaneously and a bandwidth; capability information about the quantity of BWPs capable of being configured for the UE simultaneously in different carriers and a bandwidth in the case of CA; capability information about the quantity of BWPs capable of being configured for the UE simultaneously in different carriers and a bandwidth in the case of DC; capability information about the quantity of BWPs capable of being activated by the UE simultaneously in different carriers and a bandwidth in the case of CA; capability information about the quantity of BWPs capable of being activated by the UE simultaneously in different carriers and a bandwidth in the case of DC; MIMO capability information about each BWP to be supported by the UE; numerology information about each BWP to be supported by the UE; first indication information indicating whether the UE has a cross-BWP scheduling capability; second indication information indicating whether the UE has a fast switching capability; BWP measurement gap capability information about the UE; third indication information indicating whether the UE has a capability of measuring, at a current BWP, different measurement items of the current BWP; fourth indication information indicating whether the UE has a capability of measuring, at one BWP, different measurement items of the other BWP; fifth indication information indicating whether a measurement gap needs to be configured for the UE when the UE has the capability of measuring, at one BWP, different measurement items of the other BWP; sixth indication information indicating whether a measurement gap needs to be configured for the UE when the UE needs to transmit an SRS; and seventh indication information indicating whether a measurement gap needs to be configured for the UE when the UE performs intra-frequency multiple-beam measurement on one BWP.

The measurement items may include at least one of RSRP, RSRQ, an SINR, RSSI and CQI.

The air interface parameter set may include an air interface parameter type. The air interface parameter type may include at least one of: a first air interface parameter indicating that merely one BWP is capable of being configured or activated in a current carrier; a second air interface parameter indicating that at least two BWPs at consecutive positions are capable of being configured or activated in the current carrier; a third air interface parameter indicating that at least two BWPs at inconsecutive positions are capable of being configured or activated in the current carrier; a fourth air interface parameter indicating that at least two BWPs at different positions are capable of being configured or activated in the current carrier; and a fifth air interface parameter indicating that at least one BWP at a predetermined position is capable of being configured or activated in the other carrier, the other carrier being a carrier other than the current carrier.

The fourth reception module 720 may include a second reception sub-module configured to receive at least one BWP and the air interface parameter set of the at least one BWP configured by the network device in accordance with the UE capability information through a broadcast message or preset signaling.

The second reception sub-module may include a first reception unit configured to receive information about a correspondence between uplink and downlink BWPs in the air interface parameter set of the at least one BWP configured by the network device in accordance with the UE capability information. The uplink and downlink BWPs may be a BWP pair consisting of an uplink BWP and a downlink BWP. The information about the correspondence between the uplink and downlink BWPs may include at least one of information about a feedback relationship between the uplink and downlink BWPs, scheduling information about the uplink and downlink BWPs, information about TA of the uplink and downlink BWPs, and path loss information about the uplink and downlink BWPs.

The first reception unit may include: a first reception sub-unit configured to receive the information about the correspondence between the uplink and downlink BWPs in the air interface parameter set of the at least one BWP configured by the network device in accordance with the UE capability information through carrying a configuration of one of the uplink and downlink BWPs in a configuration of the other one of the uplink downlink BWPs; or a second reception sub-unit configured to receive the information about the correspondence between the uplink and downlink BWPs in the air interface parameter set of the at least one BWP configured by the network device in accordance with the UE capability information through providing the uplink and downlink BWPs with a same configuration; or a third reception sub-unit configured to receive the information about the correspondence between the uplink and downlink BWPs in the air interface parameter set of the at least one BWP configured by the network device in accordance with the UE capability information through configuring a predetermined variable.

The UE 700 may include: a fifth transmission module configured to transmit request information for requesting OSI to the network device in accordance with the air interface parameter set; and a fifth reception module configured to receive the OSI requested by the request information from the network device through the at least one BWP configured for the UE.

The fifth transmission module may include a second transmission sub-module configured to transmit the request information for requesting the OSI to the network device through MSG1 or MSG3.

The UE 700 may further include: a sixth reception module configured to receive L1/L2/L3 measurement configuration information at a designated BWP of the at least one BWP form the network device; and a sixth transmission module configured to perform measurement in accordance with the measurement configuration information to acquire measurement report information and report the measurement report information to the network device, so that the network device updates the air interface parameter set for the UE in accordance with the measurement report information.

The UE 700 may further include a seventh reception module configured to receive information about to-be-added or to-be-modified BWPs from the network device. The information about the BWPs may include at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP, configuration information about a Random Access Channel (RACH) for the UE with respect to each to-be-added or to-be-modified BWP, information about a power control parameter of the UE with respect to each to-be-added or to-be-modified BWP, cross-BWP scheduling configuration information, and configuration information about a physical channel for the UE with respect to each to-be-added or to-be-modified BWP.

The UE 700 may further include an eighth reception module configured to receive information about a list of to-be-deleted BWPs from the network device.

It should be appreciated that, according to the embodiments of the present disclosure, the UE may report its own UE capability information to the network device, so that the network device may flexibly configure the corresponding BWP and the air interface parameter set for the UE in accordance with the UE capability information. As a result, it is able to configure the air interface parameters in accordance with the BWPs which cannot be solved in related art.

It should be further appreciated that, the above modules of the network device and the UE are divided merely on the basis of their logic functions, and in actual use, they may be completely or partially integrated into a physical entity, or physically separated from each other. These modules may be implemented by calling software through a processing element, or implemented in the form of hardware. For example, the determination module may be a processing element arranged separately, or integrated into a chip of the above-mentioned device. In addition, these modules may be stored in the memory of the above-mentioned device in the form of a program code, and may be called and executed by a processing element of the above-mentioned device so as to achieve the above functions of the determination module. The other modules may be implemented in a similar manner. All or parts of the modules may be integrated together or arranged separately. Here, the modules, units or assemblies may each of an Integrated Circuit (IC) having a signal processing capability. During the implementation, the steps of the method or the modules may be implemented through an integrated logic circuit of the processing element in the form of hardware or through instructions in the form of software.

For example, the above modules may be one or more ICs capable of implementing the above-mentioned method, e.g., one or more Application Specific Integrated Circuits (ASICs), one or more Digital Signal Processors (DSPs), or one or more Field Programmable Gate Array (FPGA). For another example, when a certain module is implemented by calling a program code through a processing element, the processing element may be a general-purpose processor, e.g., a Central Processing Unit (CPU) or any other processor capable of calling the program code. These modules may be integrated together and implemented in the form of system-on-a-chip (SOC).

In order to achieve the above-mentioned purposes in a better manner, the present disclosure further provides in some embodiments a UE, including a processor, a memory, and a computer program stored in the memory and executed by the processor. The processor is configured to execute the computer program, so as to implement the above-mentioned BWP configuration method. The present disclosure further provides in some embodiments a computer-readable storage medium storing therein a computer program. The computer program is executed by a processor so as to implement the above-mentioned BWP configuration method.

As shown in FIG. 8, the present disclosure further provides in some embodiments a UE 800, including at least one processor 801, a memory 802, a user interface 803 and a network interface 804. The components of the UE 800 may be coupled together through a bus system 805. It should be appreciated that, the bus system 805 is configured to achieve connection and communication among the components. Apart from a data bus, the bus system 805 may further include a power source bus, a control bus and a state signal bus. For clarification, all these buses in FIG. 8 may be collectively called as bus system 805.

The user interface 803 may include a display, a keyboard or a pointing device (e.g., mouse, track ball, touch plate or touch panel).

It should be appreciated that, the memory 802 may be a volatile memory, a nonvolatile memory or both. The nonvolatile memory may be a Read-Only Memory (ROM), a Programmable ROM (PROM), an Erasable PROM (EPROM), an electrically EPROM (EEPROM) or a flash memory. The volatile memory may be a Random Access Memory (RAM) which serves as an external high-speed cache. Illustratively but nonrestrictively, the RAM may include Static RAM (SRAM), Dynamic RAM (DRAM), Synchronous DRAM (SDRAM), Double Data Rate SDRAM (DDRSDRAM), Enhanced SDRAM (ESDRAM), Synchronous Link DRAM (SLDRAM) or Direct Rambus RAM (DRRAM). The memory 802 intends to include, but not limited to, the above-mentioned and any other appropriate memories.

In a possible embodiment of the present disclosure, the following elements may be stored in the memory 802: an executable module or data structure, a subset or an extended set thereof, an operating system 8021 and an application 8022.

The operating system 8021 may include various system programs, e.g., a framework layer, a core layer and a driving layer, so as to implement various basic services and process hardware-based tasks. The application 8022 may include various applications, e.g., Media Player and Browser, so as to implement various application services. The programs for implementing the above-mentioned method may be included in the application 8022.

In the embodiments of the present disclosure, the UE 800 may further include a computer program stored in the memory 802 and executed by the processor 801, e.g., a computer program in the application 8022. The processor 801 is configured to execute the compute program, so as to: report UE capability information carrying BWP capability information to a network device; and receive an air interface parameter set of at least one BWP configured by the network device in accordance with the UE capability information. The air interface parameter set may include at least one air interface parameter of the BWP.

The above-mentioned method may be applied to, or implemented by, the processor 801. The processor 801 may be an integrated circuit (IC) having a signal processing capability. During the implementation, the steps of the above-mentioned method may be completed through an integrated logic circuit of hardware in the processor 801 or instructions in the form of software. The processor 801 may be a general-purpose processor, a digital signal processor, an application-specific integrated circuit (ASIC), a field programmable gate array (FPGA) or any other programmable logic element, a discrete gate or transistor logic element, or a discrete hardware assembly, which may be used to implement or execute the methods, steps or logic diagrams in the embodiments of the present disclosure. The general purpose processor may be a microprocessor or any other conventional processor. The steps of the method in the embodiments of the present disclosure may be directly implemented by the processor in the form of hardware, or a combination of hardware and software modules in the processor. The software module may be located in a known storage medium such as an RAM, a flash memory, an ROM, a PROM, an EEPROM, or a register. The storage medium may be located in the memory 802, and the processor 801 may read information stored in the memory 802 so as to implement the steps of the method in conjunction with the hardware.

It should be appreciated that, the embodiments of the present disclosure may be implemented by hardware, software, firmware, middleware, microcode or a combination thereof. For the hardware implementation, the processor may include one or more of an ASIC, a DSP, a DSP device (DSPD), a Programmable Logic Device (PLD), an FPGA, a general-purpose processor, a controller, a microcontroller, a microprocessor, any other electronic unit capable of achieving the functions in the present disclosure, or a combination thereof.

For the software implementation, the scheme in the embodiments of the present disclosure may be implemented through modules capable of achieving the functions in the present disclosure (e.g., processes or functions). Software codes may be stored in the memory and executed by the processor. The memory may be implemented inside or outside the processor.

To be specific, the UE capability information may include at least one of: capability information about the maximum quantity of BWPs capable of being configured for the UE simultaneously for uplink or downlink transmission and a bandwidth; capability information about the maximum quantity of BWPs capable of being activated by the UE simultaneously for the uplink or downlink transmission and a bandwidth; capability information about the quantity of consecutive or inconsecutive BWPs in a same carrier capable of being configured for the UE simultaneously and a bandwidth; capability information about the quantity of consecutive or inconsecutive BWPs in a same carrier capable of being activated by the UE simultaneously and a bandwidth; capability information about the quantity of BWPs capable of being configured for the UE simultaneously in different carriers and a bandwidth in the case of Carrier Aggregation (CA); capability information about the quantity of BWPs capable of being configured for the UE simultaneously in different carriers and a bandwidth in the case of Dual Connectivity (DC); capability information about the quantity of BWPs capable of being activated by the UE simultaneously in different carriers and a bandwidth in the case of CA; capability information about the quantity of BWPs capable of being activated by the UE simultaneously in different carriers and a bandwidth in the case of DC; Multiple-Input Multiple-Output (MIMO) capability information about each BWP to be supported by the UE; numerology information about each BWP to be supported by the UE, including a subcarrier spacing and a Cyclic Prefix (CP); first indication information indicating whether the UE has a cross-BWP scheduling capability; second indication information indicating whether the UE has a fast switching capability, i.e., indicating whether the UE has a transceiving capability of rapidly retuning from one BWP to another BWP provided that a certain performance requirement has been met; information about a retuning time length when the UE has the fast switching capability; BWP measurement gap capability information about the UE, i.e., information indicating whether a measurement gap needs to be provided for the measurement of another BWP when the UE operates at a certain BWP; third indication information indicating whether the UE has a capability of measuring, at a current BWP, different measurement items of the current BWP, i.e., indicating whether the UE has a capability of measuring, at a certain BWP, different measurement items of the BWP; fourth indication information indicating whether the UE has a capability of measuring, at one BWP, different measurement items of the other BWP; fifth indication information indicating whether a measurement gap needs to be configured for the UE when the UE has the capability of measuring, at one BWP, different measurement items of the other BWP, i.e., indicating whether the measurement gap needs to be configured for the UE during the measurement of a certain measurement item; sixth indication information indicating whether a measurement gap needs to be configured for the UE when the UE needs to transmit an SRS; and seventh indication information indicating whether a measurement gap needs to be configured for the UE when the UE performs intra-frequency multiple-beam measurement on one BWP.

To be specific, the measurement items may include at least one of RSRP, RSRQ, an SINR, RSSI and CQI.

The air interface parameter set may include an air interface parameter type. The air interface parameter type may include at least one of: a first air interface parameter indicating that merely one BWP is capable of being configured or activated in a current carrier; a second air interface parameter indicating that at least two BWPs at consecutive positions are capable of being configured or activated in the current carrier; a third air interface parameter indicating that at least two BWPs at inconsecutive positions are capable of being configured or activated in the current carrier; a fourth air interface parameter indicating that at least two BWPs at different positions are capable of being configured or activated in the current carrier; and a fifth air interface parameter indicating that at least one BWP at a predetermined position is capable of being configured or activated in the other carrier, the other carrier being a carrier other than the current carrier.

To be specific, the processor 801 is further configured to execute the computer program, so as to receive at least one BWP and the air interface parameter set of the at least one BWP configured by the network device in accordance with the UE capability information through a broadcast message or preset signaling.

To be specific, the processor 801 is further configured to execute the computer program, so as to receive information about a correspondence between uplink and downlink BWPs in the air interface parameter set of the at least one BWP configured by the network device in accordance with the UE capability information. The uplink and downlink BWPs may be a BWP pair consisting of an uplink BWP and a downlink BWP. The information about the correspondence between the uplink and downlink BWPs may include at least one of information about a feedback relationship between the uplink and downlink BWPs, scheduling information about the uplink and downlink BWPs, information about TA of the uplink and downlink BWPs, and path loss information about the uplink and downlink BWPs.

To be specific, the processor 801 is further configured to execute the computer program, so as to: receive the information about the correspondence between the uplink and downlink BWPs in the air interface parameter set of the at least one BWP configured by the network device in accordance with the UE capability information through carrying a configuration of one of the uplink and downlink BWPs in a configuration of the other one of the uplink downlink BWPs; or receive the information about the correspondence between the uplink and downlink BWPs in the air interface parameter set of the at least one BWP configured by the network device in accordance with the UE capability information through providing the uplink and downlink BWPs with a same configuration; or receive the information about the correspondence between the uplink and downlink BWPs in the air interface parameter set of the at least one BWP configured by the network device in accordance with the UE capability information through configuring a predetermined variable.

To be specific, the processor 801 is further configured to execute the computer program, so as to: transmit request information for requesting OSI to the network device in accordance with the air interface parameter set; and receive the OSI requested by the request information from the network device through the at least one BWP configured for the UE.

To be specific, the processor 801 is further configured to execute the computer program, so as to transmit the request information for requesting the OSI to the network device through MSG1 or MSG3.

To be specific, the processor 801 is further configured to execute the computer program, so as to: receive L1/L2/L3 measurement configuration information at a designated BWP of the at least one BWP from the network device; and perform measurement in accordance with the measurement configuration information to acquire measurement report information and report the measurement report information to the network device, so that the network device updates the air interface parameter set for the UE in accordance with the measurement report information.

To be specific, the processor 801 is further configured to execute the computer program, so as to receive information about to-be-added or to-be-modified BWPs from the network device. The information about the BWPs may include at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP, configuration information about a Random Access Channel (RACH) for the UE with respect to each to-be-added or to-be-modified BWP, information about a power control parameter of the UE with respect to each to-be-added or to-be-modified BWP, cross-BWP scheduling configuration information, and configuration information about a physical channel for the UE with respect to each to-be-added or to-be-modified BWP.

To be specific, the processor 801 is further configured to execute the computer program, so as to receive information about a list of to-be-deleted BWPs from the network device.

The UE may be a wireless UE or a wired UE. The wireless UE may be a device capable of providing voice data and/or any other service data to a user, e.g., a handheld device having a wireless connection function, or any other processing device capable of being connected to a wireless modem. The wireless UE may communicate with one or more core networks via a Radio Access Network (RAN). The wireless UE may be a mobile terminal, e.g., a mobile phone (or cellular phone), or a computer having the mobile terminal, e.g., a portable, pocket-sized, handheld, built-in or vehicle-mounted mobile device, which are capable of exchanging voice and/or data with the RAN. For example, the wireless UE may be a Personal Communication Service (PCS) telephone, a cordless telephone, a Session Initiation Protocol (SIP) phone, a Wireless Local Loop (WLL) station, or a Personal Digital Assistant (PDA). In addition, the wireless terminal may also be called as system, subscriber unit, subscriber station, mobile station, mobile, remote station, remote terminal, access terminal, user terminal, user agent or user device, which will not be particularly defined herein.

According to the embodiments of the present disclosure, the UE may report its own UE capability information to the network device, so that the network device may flexibly configure the corresponding BWP and the air interface parameter set for the UE in accordance with the UE capability information. As a result, it is able to configure the air interface parameters in accordance with the BWPs which cannot be solved in related art.

It should be appreciated that, units and steps described in the embodiments of the present disclosure may be implemented in the form of electronic hardware, or a combination of a computer program and the electronic hardware. Whether or not these functions are executed by hardware or software depends on specific applications or design constraints of the technical solution. Different methods may be adopted with respect to the specific applications so as to achieve the described functions, without departing from the scope of the present disclosure.

It should be further appreciated that, for convenience and clarification, operation procedures of the system, device and units described hereinabove may refer to the corresponding procedures in the method embodiment, and thus will not be particularly defined herein.

It should be further appreciated that, the device and method may be implemented in any other ways. For example, the embodiments for the apparatus is merely for illustrative purposes, and the modules or units are provided merely on the basis of their logic functions. During the actual application, some modules or units may be combined together or integrated into another system. Alternatively, some functions of the module or units may be omitted or not executed. In addition, the coupling connection, direct coupling connection or communication connection between the modules or units may be implemented via interfaces, and the indirect coupling connection or communication connection between the modules or units may be implemented in an electrical or mechanical form or in any other form.

The units may be, or may not be, physically separated from each other. The units for displaying may be, or may not be, physical units, i.e., they may be arranged at an identical position, or distributed on a plurality of network elements. Parts or all of the units may be selected in accordance with the practical need, so as to achieve the purpose of the present disclosure.

In addition, the functional units in the embodiments of the present disclosure may be integrated into a processing unit, or the functional units may exist independently, or two or more functional units may be combined together.

In the case that the functional units are implemented in a software form and sold or used as a separate product, they may be stored in a computer-readable medium. Based on this, the technical solutions of the present disclosure, partial or full, or parts of the technical solutions of the present disclosure contributing to the related art, may appear in the form of software products, which may be stored in a storage medium and include several instructions so as to enable computer equipment (a personal computer, a server or network equipment) to execute all or parts of the steps of the method according to the embodiments of the present disclosure. The storage medium includes any medium capable of storing therein program codes, e.g., a universal serial bus (USB) flash disk, a mobile hard disk (HD), a read-only memory (ROM), a random access memory (RAM), a magnetic disk or an optical disk.

It should be further appreciated that, according to the device and the method in the embodiments of the present disclosure, the members and/or steps may be subdivided and/or recombined, which shall also be deemed as equivalents of the present disclosure. In addition, the steps for executing the above-mentioned processings may be performed in a chronological order. Of course, some steps may also be performed in parallel, or independently of each other. It should be further appreciated that, after reading the descriptions of the present disclosure, it is able for a person skilled in the art, using a basic programming skill, to implement any or all steps of the method and any or all members of the device in any computing device (including a processor and a storage medium) or a network consisting of the computing devices, in the form of hardware, firmware, software or a combination thereof.

Hence, the purposes of the present disclosure may also be implemented by one program or a set of programs running on any computing device, e.g., a known general-purpose computer, or implemented merely by a program product including programs codes capable of implementing the method or device. In other words, this program product and a storage medium storing therein the program product also constitute a part of the present disclosure. Obviously, the storage medium may be any known storage medium or a storage medium that may occur in future. It should be further appreciated that, according to the device and the method in the embodiments of the present disclosure, the members and/or steps may be subdivided and/or recombined, which shall also be deemed as equivalents of the present disclosure. In addition, the steps for executing the above-mentioned processings may be performed in a chronological order. Of course, some steps may also be performed in parallel, or independently of each other.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A Bandwidth Part (BWP) configuration method applied for a network device, comprising:
receiving User Equipment (UE) capability information carrying BWP capability information reported by a UE; and
configuring an air interface parameter set of at least one BWP for the UE in accordance with the UE capability information, the air interface parameter set comprising at least one air interface parameter of the BWP.

2. The BWP configuration method according to claim 1, wherein the UE capability information comprises at least one of:
capability information about the maximum quantity of BWPs capable of being configured for the UE simultaneously for uplink or downlink transmission and a bandwidth;
capability information about the maximum quantity of BWPs capable of being activated by the UE simultaneously for the uplink or downlink transmission and a bandwidth;
capability information about the quantity of consecutive or inconsecutive BWPs in a same carrier capable of being configured for the UE simultaneously and a bandwidth;
capability information about the quantity of consecutive or inconsecutive BWPs in a same carrier capable of being activated by the UE simultaneously and a bandwidth;
capability information about the quantity of BWPs capable of being configured for the UE simultaneously in different carriers and a bandwidth in the case of Carrier Aggregation (CA);
capability information about the quantity of BWPs capable of being configured for the UE simultaneously in different carriers and a bandwidth in the case of Dual Connectivity (DC);
capability information about the quantity of BWPs capable of being activated by the UE simultaneously in different carriers and a bandwidth in the case of CA;
capability information about the quantity of BWPs capable of being activated by the UE simultaneously in different carriers and a bandwidth in the case of DC;
Multiple-Input Multiple-Output (MIMO) capability information about each BWP to be supported by the UE;
numerology information about each BWP to be supported by the UE;
first indication information indicating whether the UE has a cross-BWP scheduling capability;
second indication information indicating whether the UE has a fast switching capability;
information about a retuning time length when the UE has the fast switching capability;
BWP measurement gap capability information about the UE;
third indication information indicating whether the UE has a capability of measuring, at a current BWP, different measurement items of the current BWP;
fourth indication information indicating whether the UE has a capability of measuring, at one BWP, different measurement items of the other BWP;
fifth indication information indicating whether a measurement gap needs to be configured for the UE when the UE has the capability of measuring, at one BWP, different measurement items of the other BWP;
sixth indication information indicating whether a measurement gap needs to be configured for the UE when the UE needs to transmit a Sounding Reference Signal (SRS); and
seventh indication information indicating whether a measurement gap needs to be configured for the UE when the UE performs intra-frequency multiple-beam measurement on one BWP.

3. (canceled)

4. The BWP configuration method according to claim 1, wherein,
the air interface parameter set comprises an air interface parameter type,
the air interface parameter type comprises at least one of: a first air interface parameter indicating that merely one BWP is capable of being configured or activated in a current carrier; a second air interface parameter indicating that at least two BWPs at consecutive positions are capable of being configured or activated in the current carrier; a third air interface parameter indicating that at least two BWPs at inconsecutive positions are capable of being configured or activated in the current carrier; a fourth air interface parameter indicating that at least three BWPs at consecutive positions and inconsecutive positions are capable of being configured or activated in the current carrier; or a fifth air interface parameter indicating that at least one BWP at a predetermined position is capable of being configured or activated in the other carrier, and
the other carrier is a carrier other than the current carrier.

5. The BWP configuration method according to claim 1, wherein the configuring the air interface parameter set of the at least one BWP for the UE in accordance with the UE capability information comprises:
configuring at least one BWP and the air interface parameter set of the at least one BWP for the UE in accordance with the UE capability information; and
transmitting the air interface parameter set of the at least one BWP to the UE through a broadcast message or preset signaling.

6. The BWP configuration method according to claim 5, wherein the transmitting the air interface parameter set of the at least one BWP to the UE through the broadcast message or preset signaling comprises:
transmitting information about a correspondence between uplink and downlink BWPs in the air interface parameter set of the at least one BWP to the UE through the broadcast message or the preset signaling,
wherein the uplink and downlink BWPs comprise a BWP pair consisting of an uplink BWP and a downlink BWP, and the information about the correspondence between the uplink and downlink BWPs comprises at least one of information about a feedback relationship between the uplink and downlink BWPs, scheduling information about the uplink and downlink BWPs, information about Timing Advance (TA) of the uplink and downlink BWPs, or path loss information about the uplink and downlink BWPs.

7. The BWP configuration method according to claim 6, wherein the transmitting the information about the correspondence between the uplink and downlink BWPs in the air interface parameter set of the at least one BWP to the UE comprises:
transmitting the information about the correspondence between the uplink and downlink BWPs in the air interface parameter set of the at least one BWP to the UE through carrying a configuration of one of the uplink and downlink BWPs in a configuration of the other one of the uplink downlink BWPs; or
transmitting the information about the correspondence between the uplink and downlink BWPs in the air interface parameter set of the at least one BWP to the UE through providing the uplink and downlink BWPs with a same configuration; or
transmitting the information about the correspondence between the uplink and downlink BWPs in the air interface parameter set of the at least one BWP to the UE through configuring a predetermined variable.

8.-10. (canceled)

11. The BWP configuration method according to claim 1, wherein subsequent to configuring the air interface parameter set of the at least one BWP for the UE in accordance with the UE capability information, the BWP configuration method further comprises:
transmitting L1/L2/L3 measurement configuration information at a designated BWP of the at least one BWP to the UE in accordance with the air interface parameter set of the at least one BWP;
receiving measurement report information reported by the UE after the measurement in accordance with the measurement configuration information; and
updating the air interface parameter set for the UE in accordance with the measurement report information.

12. (canceled)

13. The BWP configuration method according to claim 1, wherein subsequent to configuring the air interface parameter set of the at least one BWP for the UE in accordance with the UE capability information, the BWP configuration method further comprises:
transmitting, when it is necessary to add or modify the BWPs for the UE, information about the to-be-added or to-be-modified BWPs to the UE,
wherein the information about the BWPs comprises at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP, configuration information about a Random Access Channel (RACH) for the UE with respect to each to-be-added or to-be-modified BWP, information about a power control parameter of the UE with respect to each to-be-added or to-be-modified BWP, cross-BWP scheduling configuration information, or configuration information about a physical channel for the UE with respect to each to-be-added or to-be-modified BWP.

14. The BWP configuration method according to claim 1, wherein subsequent to configuring the air interface parameter set of the at least one BWP for the UE in accordance with the UE capability information, the BWP configuration method further comprises:
transmitting, when it is necessary to delete the BWPs for the UE, information about a list of to-be-deleted BWPs to the UE.

15.-28. (canceled)

29. A network device, comprising a processor, a memory, and a program stored in the memory and executed by the processor, wherein the processor is configured to execute the program so as to implement the BWP configuration method according to claim 1.

30. (canceled)

31. A BWP configuration method applied for a UE, comprising:
reporting UE capability information carrying BWP capability information to a network device; and
receiving an air interface parameter set of at least one BWP configured by the network device in accordance with the UE capability information,
wherein the air interface parameter set comprises at least one air interface parameter of the BWP.

32. The BWP configuration method according to claim 31, wherein the UE capability information comprises at least one of:
capability information about the maximum quantity of BWPs capable of being configured for the UE simultaneously for uplink or downlink transmission and a bandwidth;
capability information about the maximum quantity of BWPs capable of being activated by the UE simultaneously for the uplink or downlink transmission and a bandwidth;
capability information about the quantity of consecutive or inconsecutive BWPs in a same carrier capable of being configured for the UE simultaneously and a bandwidth;
capability information about the quantity of consecutive or inconsecutive BWPs in a same carrier capable of being activated by the UE simultaneously and a bandwidth;
capability information about the quantity of BWPs capable of being configured for the UE simultaneously in different carriers and a bandwidth in the case of CA;
capability information about the quantity of BWPs capable of being configured for the UE simultaneously in different carriers and a bandwidth in the case of DC;
capability information about the quantity of BWPs capable of being activated by the UE simultaneously in different carriers and a bandwidth in the case of CA;
capability information about the quantity of BWPs capable of being activated by the UE simultaneously in different carriers and a bandwidth in the case of DC;
MIMO capability information about each BWP to be supported by the UE;
numerology information about each BWP to be supported by the UE;
first indication information indicating whether the UE has a cross-BWP scheduling capability;
second indication information indicating whether the UE has a fast switching capability;
information about a retuning time length when the UE has the fast switching capability;
BWP measurement gap capability information about the UE;
third indication information indicating whether the UE has a capability of measuring, at a current BWP, different measurement items of the current BWP;
fourth indication information indicating whether the UE has a capability of measuring, at one BWP, different measurement items of the other BWP;
fifth indication information indicating whether a measurement gap needs to be configured for the UE when the UE has the capability of measuring, at one BWP, different measurement items of the other BWP;
sixth indication information indicating whether a measurement gap needs to be configured for the UE when the UE needs to transmit an SRS; and
seventh indication information indicating whether a measurement gap needs to be configured for the UE when the UE performs intra-frequency multiple-beam measurement on one BWP.

33. (canceled)

34. The BWP configuration method according to claim 31, wherein,
the air interface parameter set comprises an air interface parameter type,
the air interface parameter type comprises at least one of: a first air interface parameter indicating that merely one BWP is capable of being configured or activated in a current carrier a second air interface parameter indicating that at least two BWPs at consecutive positions are capable of being configured or activated in the current carrier; a third air interface parameter indicating that at least two BWPs at inconsecutive positions are capable of being configured or activated in the current carrier; a fourth air interface parameter indicating that at least two BWPs at different positions are capable of being configured or activated in the current carrier; or a fifth air interface parameter indicating that at least one BWP at a predetermined position is capable of being configured or activated in the other carrier, and
the other carrier is a carrier other than the current carrier.

35. The BWP configuration method according to claim 31, wherein the receiving the air interface parameter set of the at least one BWP configured by the network device in accordance with the UE capability information comprises: receiving at least one BWP and the air interface parameter set of the at least one BWP configured by the network device in accordance with the UE capability information through a broadcast message or preset signaling.

36. The BWP configuration method according to claim 35, wherein the receiving the at least one BWP and the air interface parameter set of the at least one BWP configured by the network device in accordance with the UE capability information comprises:
receiving information about a correspondence between uplink and downlink BWPs in the air interface parameter set of the at least one BWP configured by the network device in accordance with the UE capability information,
wherein the uplink and downlink BWPs comprise a BWP pair consisting of an uplink BWP and a downlink BWP, and the information about the correspondence between the uplink and downlink BWPs comprises at least one of information about a feedback relationship between the uplink and downlink BWPs, scheduling information about the uplink and downlink BWPs, information about TA of the uplink and downlink BWPs, or path loss information about the uplink and downlink BWPs.

37. The BWP configuration method according to claim 36, wherein the receiving the information about the correspondence between the uplink and downlink BWPs in the air interface parameter set of the at least one BWP configured by the network device in accordance with the UE capability information comprises:
receiving the information about the correspondence between the uplink and downlink BWPs in the air interface parameter set of the at least one BWP configured by the network device in accordance with the UE capability information through carrying a configuration of one of the uplink and downlink BWPs in a configuration of the other one of the uplink and downlink BWPs; or
receiving the information about the correspondence between the uplink and downlink BWPs in the air interface parameter set of the at least one BWP configured by the network device in accordance with the UE capability information through providing the uplink and downlink BWPs with a same configuration; or
receiving the information about the correspondence between the uplink and downlink BWPs in the air interface parameter set of the at least one BWP configured by the network device in accordance with the UE capability information through configuring a predetermined variable.

38.-39. (canceled)

40. The BWP configuration method according to claim 31, wherein subsequent to receiving the air interface parameter set of the at least one BWP configured by the network device in accordance with the UE capability information, the BWP configuration method further comprises:
receiving L1/L2/L3 measurement configuration information at a designated BWP of the at least one BWP from the network device; and
performing measurement in accordance with the measurement configuration information to acquire measurement report information and reporting the measurement report information to the network device, so that the network device updates the air interface parameter set for the UE in accordance with the measurement report information.

41. The BWP configuration method according to claim 31, wherein subsequent to receiving the air interface parameter set of the at least one BWP configured by the network device in accordance with the UE capability information, the BWP configuration method further comprises:
receiving information about to-be-added or to-be-modified BWPs from the network device,
wherein the information about the BWPs comprises at least one of index information about each to-be-added or to-be-modified BWP, central frequency point information about each to-be-added or to-be-modified BWP, bandwidth information about each to-be-added or to-be-modified BWP, antenna configuration information about each to-be-added or to-be-modified BWP, numerology information about each to-be-added or to-be-modified BWP, uplink/downlink BWP configuration information corresponding to each to-be-added or to-be-modified BWP, configuration information about an RACH for the UE with respect to each to-be-added or to-be-modified BWP, information about a power control parameter of the UE with respect to each to-be-added or to-be-modified BWP, cross-BWP scheduling configuration information, or configuration information about a physical channel for the UE with respect to each to-be-added or to-be-modified BWP.

42. The BWP configuration method according to claim 31, wherein subsequent to receiving the air interface parameter set of the at least one BWP configured by the network device in accordance with the UE capability information, the BWP configuration method further comprises:
receiving information about a list of to-be-deleted BWPs from the network device.

43.-54. (canceled)

55. A UE, comprising a processor, a memory, and a program stored in the memory and executed by the processor, wherein the processor is configured to execute the program so as to implement the BWP configuration method according to claim 31.

56. (canceled)
